(19) United States
(12) Patent Application Publication
(10) Pub. No.: US 2019/0123422 A1
(43) Pub. Date: Apr. 25, 2019

(54) ANTENNA DEVICE AND PORTABLE TERMINAL INCLUDING THE SAME

(71) Applicant: SAMSUNG ELECTRO-MECHANICS CO., LTD., Suwon-si (KR)

(72) Inventors: Doo Ho PARK, Suwon-si (KR); San KYEONG, Suwon-si (KR); Tae Jun CHOI, Suwon-si (KR); Sung Nam CHO, Suwon-si (KR); Jung Young CHO, Suwon-si (KR); Chang Hak CHOI, Suwon-si (KR); Seung Hee OH, Suwon-si (KR)

(73) Assignee: SAMSUNG ELECTRO-MECHANICS CO., LTD., Suwon-si (KR)

(21) Appl. No.: 16/004,530

(22) Filed: Jun. 11, 2018

(30) Foreign Application Priority Data
Oct. 25, 2017 (KR) 10-2017-0139110

(51) Int. Cl. H01Q 1/22; H01Q 7/08; H01Q 1/24

(52) U.S. Cl. CPC H01Q 1/2216; H01Q 1/243; H01Q 7/08

(57) ABSTRACT

An antenna device includes: a magnetic portion comprising a first surface and a second surface opposing the first surface; and a coil portion including a conductive wiring comprising a plurality of turns wound around the magnetic portion in a solenoid form, wherein in the coil portion, intervals between turns of the conductive wiring disposed on the first surface and intervals between turns of the conductive wiring disposed on the second surface are different from each other. Therefore, a recognition rate of the antenna device may be improved.

### CROSS-REFERENCE TO RELATED APPLICATION(S)

This application claims the benefit under 35 USC § 119(a) of Korean Patent Application No. 10-2017-0139110 filed on Oct. 25, 2017 in the Korean Intellectual Property Office, the entire disclosure of which is incorporated herein by reference for all purposes.

### BACKGROUND

### 1. Field

The disclosure relates to an antenna device and a portable terminal including the same.

### 2. Description of Related Art

Recently, systems for wirelessly transmitting power or having functions such as radio frequency identification (RFID), near field communications (NFC), magnetic secure transmission (MST), and the like, in order to charge batteries of portable terminals with power have been added to portable terminals.

In addition, such functions are generally performed through an antenna wiring having a coil form, and antenna devices in which the antenna wiring is formed are thus mounted in the portable terminals.

Thereamong, the NFC, the MST, and the like, have been used in several services such as a traffic service, a ticket service, a payment service, and the like.

However, most antenna wirings have been formed of a simple spiral pattern, such that a recognition rate of the antenna device is decreased in a wireless communications process depending on the manner of access between, and positions of, the antenna wiring and a reader.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an antenna device includes a magnetic portion including a first surface and a second surface opposing the first surface and a coil portion including conductive wiring comprising a plurality of turns wound around the magnetic portion in a solenoid form, wherein in the coil portion, intervals between turns of the conductive wiring disposed on the first surface and intervals between turns of the conductive wiring disposed on the second surface are different from each other.

The conductive wiring included in the coil portion may be differentially disposed in a first section, in a central portion of the magnetic portion, and second sections at respective end portions of the magnetic portion, and intervals between turns of the conductive wiring in the first section and intervals between turns of the conductive wiring in the second sections may be different from each other.

In the conductive wiring included in the coil portion, the intervals between turns of the conductive wiring disposed on the second surface, in the second sections, may be greater than the intervals between turns of the conductive wiring disposed on the first surface in the second sections.

In the conductive wiring included in the coil portion, the intervals between the turns of the conductive wiring disposed on the second surface may be increased respectively toward the end portions of the magnetic portion.

All of the intervals between the turns of the conductive wiring disposed on the first surface may be substantially the same.

The intervals between turns of the conductive wiring disposed on the first surface, in the second sections, may be smaller than the intervals of between turns of the conductive wiring disposed on the first surface in the first section.

The first surface of the magnetic portion may have an area smaller than that of the second surface of the magnetic portion, and both end portions of the magnetic portion may include inclined surfaces.

The magnetic portion may include protruding portions on both ends of the first surface, and the conductive wiring disposed on the first surface may be disposed between the protruding portions.

Insertion grooves into which the conductive wiring is inserted may be disposed in a surface of the magnetic portion.

The coil portion may include an insulating substrate into which the magnetic portion is inserted, and the conductive wiring may include thin film metal wirings on opposite surfaces of the insulating substrate.

The coil portion may include a plurality of connection conductors penetrating through the insulating substrate and electrically connecting the conductive wiring respectively disposed on the opposite surfaces of the insulating substrate to each other.

In another aspect, a portable terminal may include a terminal body, and an antenna device including a magnetic portion including a second surface facing the terminal body and a first surface opposing the second surface, and a coil portion including conductive wiring wound around the magnetic portion in a solenoid form, an entire length of the coil portion disposed on the second surface being greater than that of the coil portion disposed on the first surface.

The antenna device may be a magnetic secure transmission (MST) antenna device.

The coil portion may include an insulating substrate including the conductive wiring disposed on a surface thereof, and the magnetic portion may be disposed in a flat sheet shape and may be inserted into the insulating substrate.

The conductive wiring may be included in the coil portion, and intervals between turns of the conductive wiring disposed on the first surface and intervals between turns of the conductive wiring disposed on the second surface may be different from each other.

The conductive wiring may be included in the coil portion, the intervals between the turns of the conductive wiring disposed on the second surface may be increased respectively toward end portions of the magnetic portion.

The antenna device may be magnetically coupled to a wireless signal receiving device to wirelessly transmit information.

The antenna device may be a near field communications (NFC) antenna device or radio frequency identification (RFID) antenna device.

Other features and aspects will be apparent from the following detailed description, the drawings, and the claims.

### BRIEF DESCRIPTION OF DRAWINGS

FIG. 1 is a perspective view illustrating an example in which a portable terminal according to an embodiment performs wireless communications;

FIG. 2 is a schematic cross-sectional view taken along line I-I′ of the portable terminal according to an embodiment;

FIG. 3 is a schematic perspective view illustrating an antenna device of FIG. 2;

FIG. 4 is a bottom view of the antenna device illustrated in FIG. 3;

FIG. 5 is a side view of the antenna device illustrated in FIG. 3;

FIG. 6 is a schematic side view illustrating an antenna device according to another embodiment;

FIG. 7 is a schematic side view illustrating an antenna device according to an embodiment;

FIG. 8 is a schematic side view illustrating an antenna device according to an embodiment;

FIG. 9 is a schematic perspective view illustrating an antenna device according to an embodiment;

FIG. 10 is a perspective view illustrating the antenna device illustrated in FIG. 9 without a magnetic portion; and

FIG. 11 is a bottom view of the antenna device illustrated in FIG. 9.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

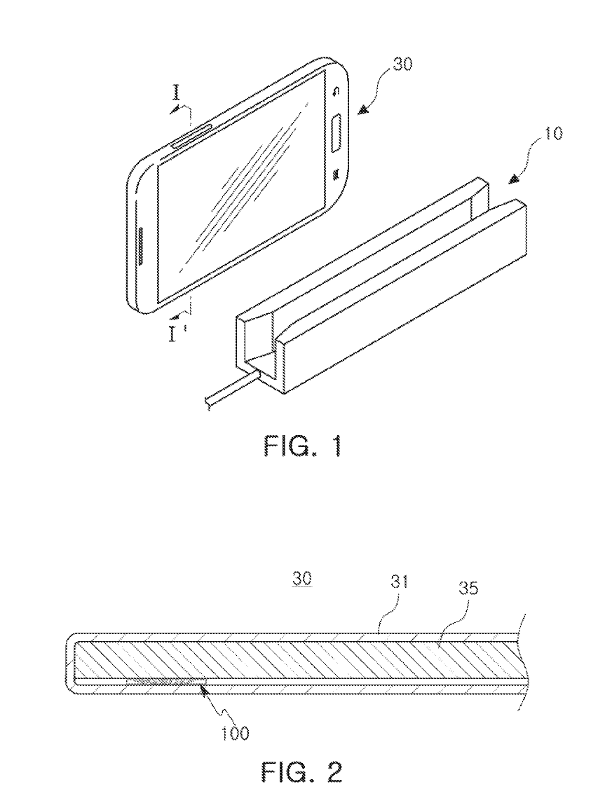

FIG. 1 is a perspective view illustrating an example in which a portable terminal according to an embodiment performs wireless communications.

A portable terminal 30 according to an embodiment may include an antenna device. The antenna device may form a magnetic field under the control of the portable terminal 30.

The antenna device may be operated as a transmitting coil, and may be magnetically coupled to a wireless signal receiving device 10 to wirelessly transmit information.

In an embodiment, the wireless signal receiving device 10 may include a magnetic card reader. However, the wireless signal receiving device 10 is not limited thereto. That is, various wireless signal receiving devices 10 may be used as long as it may perform wireless communications with the portable terminal 30.

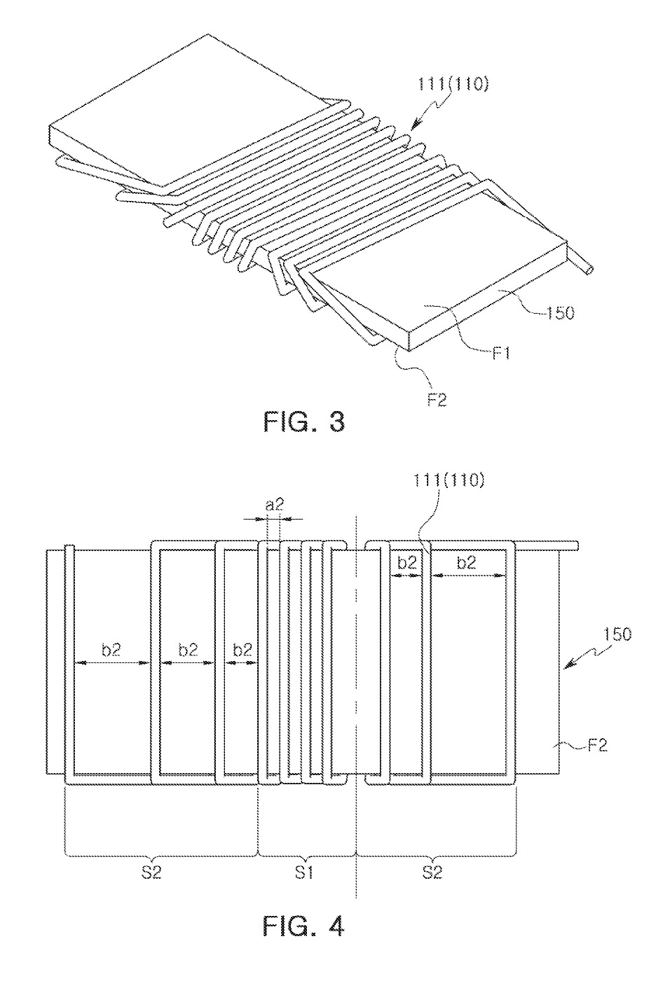

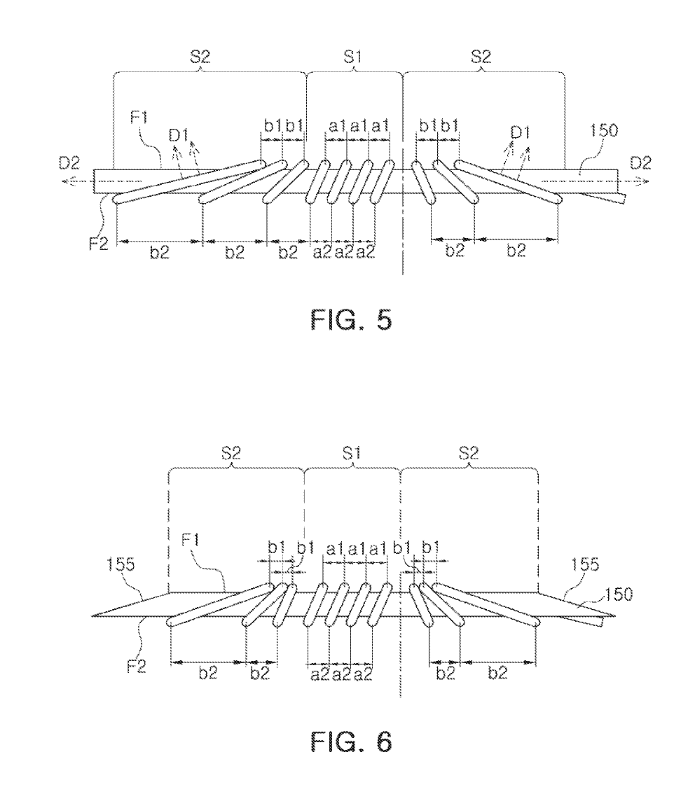

FIG. 2 is a schematic cross-sectional view taken along line I-I′ of the portable terminal according to an embodiment. FIG. 3 is a schematic perspective view illustrating an antenna device of FIG. 2, FIG. 4 is a bottom view of the antenna device illustrated in FIG. 3, and FIG. 5 is a side view of the antenna device illustrated in FIG. 3.

In an embodiment, the portable terminal 30 may include a mobile phone (or a smartphone). However, the portable terminal is not limited thereto, but may include any electronic device that is portable and may perform wireless communications, such as a laptop computer, a tablet personal computer (PC), a wearable device, or the like.

First, referring to FIG. 2, the portable terminal 30 may include a terminal body 35 to which main components are coupled for an operation of the portable terminal and an antenna device 100 performing wireless communications with the wireless signal receiving device 10 described above.

The antenna device 100 may be accommodated in a case 31 of the portable terminal 30 and be directly attached to an inner surface of the case 31 or be disposed as adjacent to the inner surface of the case 31 as possible.

Referring to FIGS. 3 through 5, the antenna device 100 may include a magnetic portion 150 and a coil portion 110.

The magnetic portion 150 may have a flat plate shape or a block shape, and may be inserted into the coil portion 110.

The magnetic portion 150 may provide a magnetic path for a magnetic field generated from the coil portion 110. Therefore, the magnetic portion 150 may be a material in which the magnetic path may be easily formed, for example, a material having a magnetic permeability, such as ferrite, a silicon steel sheet, a nanocrystal material, an amorphous material, permalloy, or the like.

In addition, the magnetic portion 150 according to an embodiment may have a first surface F1 disposed toward an outward direction when the antenna device 100 is mounted in the portable terminal 30, and a second surface F2 opposing the first surface and disposed to face the terminal body 35 as illustrated in FIG. 2.

The coil portion 110 may be formed of a conductive wire 111 having a wire shape, and may be wound around the magnetic portion 150 in a solenoid shape. In the coil portion 110 according to an embodiment, as illustrated in FIG. 5, at least some b2 of intervals a1 and b1 between turns of a conductive wire 111 disposed on the first surface F1 of the magnetic portion 150 and intervals a2 and b2 between turns of a conducting wire 111 disposed on the second surface F2 of the magnetic portion 150 may be configured to be different from one another. This will be described in more detail below.

The coil portion 110 may include a plurality of turns of the conductive wire 111 wound around the magnetic portion 150, and may be divided into a first section S1 and second sections S2 on the basis of intervals between the turns.

The first section S1 may be a portion disposed in a central portion of the magnetic portion 150 in a length direction, and a coil may be wound relatively more densely in the first section S1 than in the second section S2. Intervals a1 and a2 between continuously disposed two turns of the conductive wire 111 wound in the first section S1 may be comparatively constant. In addition, the intervals a1 and a2 may be smaller than the intervals b1 and b2 between the turns in the second section S2. Therefore, the intervals a1 and a2 between the turns in the first section S1 refer to minimum intervals of various intervals between the turns constituting the coil portion 110.

Meanwhile, in an embodiment, a case in which predetermined intervals a1 and a2 are formed between the turns in the first section S1 is described by way of example. However, the coil portion is not limited thereto. That is, the conductive wire 111 may also be wound while closely adhering the turns to each other to be in contact with each other. In this case, the intervals between the turns in the first section S1 may not be formed.

The second sections S2, which is a portion disposed at both end portions of the conductive wire 111 having a solenoid structure, may be disposed on both sides of the first section S1, respectively. Therefore, the second sections S2 may be two sections, and the first section S1 may be disposed between the two second sections S2.

Intervals b2 between continuously disposed two turns of the conductive wire 111 disposed in the second section S2 may be different from each other.

In more detail, the intervals b2 between the turns of the conductive wire 111 of the coil portion 110 disposed on the second surface F2 of the magnetic portion 150 in the second section S2 may be increased toward end portions of the magnetic portion 150. Therefore, intervals b2 between two turns wound at the outermost portions (portions adjacent to end portions of the magnetic portion) of the conductive wire 111 disposed on the second surface F2 of the second magnetic portion 150 may be largest.

For example, the intervals b2 between the turns of the conductive wire 111 disposed on the second surface F2 of the magnetic portion 150 in the second section S2 may be configured to be increased to a multiple of a1, which is the minimum interval described above, toward the end portions of the magnetic portion 150. However, the intervals b2 between the turns of the conductive wire 111 are not limited thereto.

Due to such a structure, the intervals b2 between the turns of the conductive wire 111 disposed on the second surface F2 in the second section S2 may be greater than the intervals b1 between the turns of the conductive wire 111 disposed on the first surface F1. Therefore, the intervals a1 and a2 between the turns of the conductive wire 111 in the first section S1 and the intervals b1 and b2 between the turns of the conductive wire 111 in the second section S2 may be different from each other. Therefore the coil portion 110 may be formed to be inclined toward both end portions, as illustrated in FIG. 5.

Meanwhile, the intervals b1 between the turns of the conductive wire 111 disposed on the first surface F1 of the magnetic portion 150 in the second section may be the same as or similar to the intervals a1 between the turns in the first section S1. For example, the respective turns of the conductive wire 111 disposed on the first surface F1 of the magnetic portion 150 may be disposed to be spaced apart from each other by the same interval. However, the respective turns of the conductive wire 111 disposed on the first surface F1 of the magnetic portion 150 are not limited thereto.

The coil portion 110 may perform at least one of a radio frequency identification (RFID) function, a near field communications (NFC) function, and a magnetic secure transmission (MST) function, and the antenna device may be used as an MST antenna in the present embodiment.

In the antenna device according to an embodiment configured as described above, an entire width of the coil portion 110 disposed on the second surface F2 of the magnetic portion 150 may be greater than that of the coil portion 110 disposed on the first surface F1 of the magnetic portion 150.

The coil portion 110 is configured as described above, and magnetic fields generated from end portions of the coil portion 110 may be formed in a direction D1 of FIG. 5 rather than a direction D2 of FIG. 5. Therefore, sizes of the magnetic fields may be extended toward the first surface F1 of the magnetic portion 150 as compared to the related art in which magnetic fields are formed in a length direction D2 of the magnetic portion 150.

In a wireless communications process of the portable terminal 30, the wireless signal receiving device 10 may be disposed adjacent to the first surface F1 of the magnetic portion 150. Therefore, when the sizes of the magnetic fields are extended toward the first surface F1 described above, a communications distance up to the wireless signal receiving device 10 may be extended. In addition, in a wireless communications process between the portable terminal 30 and the wireless signal receiving device 10, a high recognition rate of the antenna device may be maintained.

Meanwhile, in an embodiment, the coil portion 110 may be formed of a coated conductive wire 111. However, the coil portion 110 according to the present disclosure is not limited thereto, but may be variously modified. For example, the coil portion 110 may be formed of a press coil formed by pressing a metal plate, a flat type coil (or an edge wise coil) coated with an insulating material, or the like.

In addition, the present disclosure is not limited to the abovementioned embodiments, but may be variously modified.

FIG. 6 is a schematic side view illustrating an antenna device according to an embodiment.

Referring to FIG. 6, in the antenna device according to an embodiment, a first surface F1 of a magnetic portion 150 may have an area smaller than that of a second surface F2 of the magnetic portion 150, and both end portions of the magnetic portion 150 may be formed as inclined surfaces 155.

The inclined surfaces 155 may be formed at an angle similar to an inclination formed by the outermost turn of a coil portion 110. However, the inclined surfaces 155 are not limited thereto.

In addition, in the coil portion 110 according to an embodiment, intervals b1 between turns disposed on the first surface F1 of the magnetic portion 150 in the second section S2 may be smaller than intervals a1 between turns in the first section S1. Therefore, in an embodiment, the intervals b1 between the turns disposed on the first surface F1 of the magnetic portion 150 in the second section S2 may be defined as minimum intervals between turns.

All of the intervals b1 between the turns disposed on the first surface F1 of the magnetic portion 150 in the second section S2 may be the same as one another. However, the intervals b1 between the turns disposed on the first surface F1 of the magnetic portion 150 in the second section S2 are not limited thereto, but may be variously modified. For example, the intervals b1 between the turns disposed on the first surface F1 of the magnetic portion 150 in the second section S2 may be configured to be increased toward end portions of the magnetic portion 150 as illustrated in FIG. 6 or be decreased toward end portions of the magnetic portion 160.

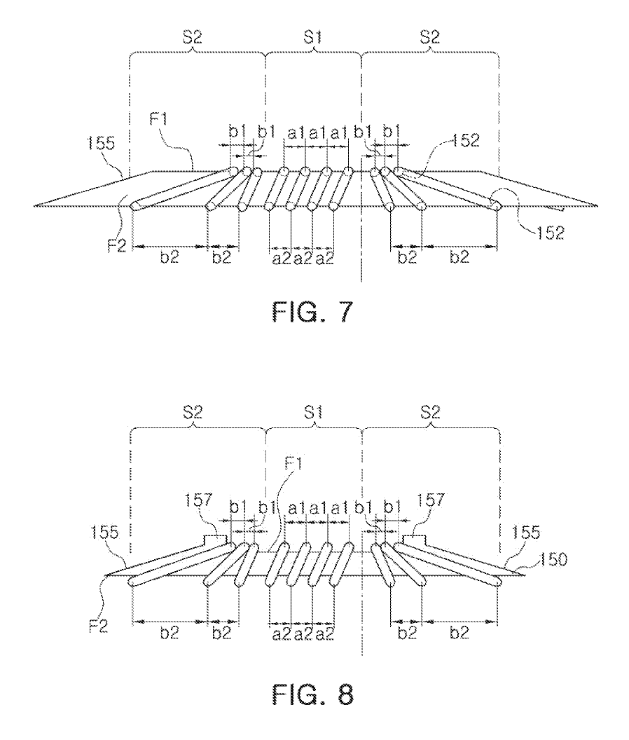

FIG. 7 is a schematic side view illustrating an antenna device according to an embodiment.

Referring to FIG. 7, in the antenna device according to an embodiment, insertion grooves 152 may be formed in a surface of a magnetic portion 150.

The insertion grooves 152 may be used as spaces into which a coil portion 110 is inserted. Therefore, the insertion grooves 152 may be formed at a width and a depth at which the coil portion 110 may be stably inserted, and may be formed along a disposition structure of the coil portion 110.

In an embodiment, the insertion grooves 152 may be grooves into which approximately a half of a circular cross section of a conductive wire forming the coil portion 110 is inserted. However, the insertion grooves 152 may be grooves having a semicircular shape. However, the insertion grooves 152 are not limited thereto, but may also be formed at a depth at which the entire conductive wire may be inserted.

In addition, in an embodiment, the insertion grooves 152 may be formed along an entire shape of the coil portion 110. However, the insertion grooves 152 are not limited thereto, but may also be partially formed in edge portions of the magnetic portion 150, a second surface F2 of the magnetic portion 150, or the like.

When the insertion grooves 152 are formed in the magnetic portion 150, deformation of a shape or a shape of the coil portion 110 wound around the magnetic portion 150 may be suppressed.

FIG. 8 is a schematic side view illustrating an antenna device according to an embodiment.

Referring to FIG. 8, the antenna device according to an embodiment may be configured to be similar to the antenna device illustrated in FIG. 5, and protruding portions 157 may be formed on both ends of a first surface F1 of a magnetic portion 150.

The protruding portions 157 may further protrude as compared to a thickness of a coil portion 110. Therefore, the coil portion 110 may be disposed between two protruding portions 157, and be wound around the magnetic portion 150.

Since the protruding portions 157 are provided, movement of the coil portion 110 disposed on the first surface F1 of the magnetic portion 150 may be suppressed, such that the coil portion 110 disposed on the first surface F1 of the magnetic portion 150 may not be separated externally from the magnetic portion 150. Therefore, even though the inclined surfaces 155 are formed at both ends of the magnetic portion 150 and are disposed adjacent to the coil portion 110, a shape of the coil portion 110 may be maintained.

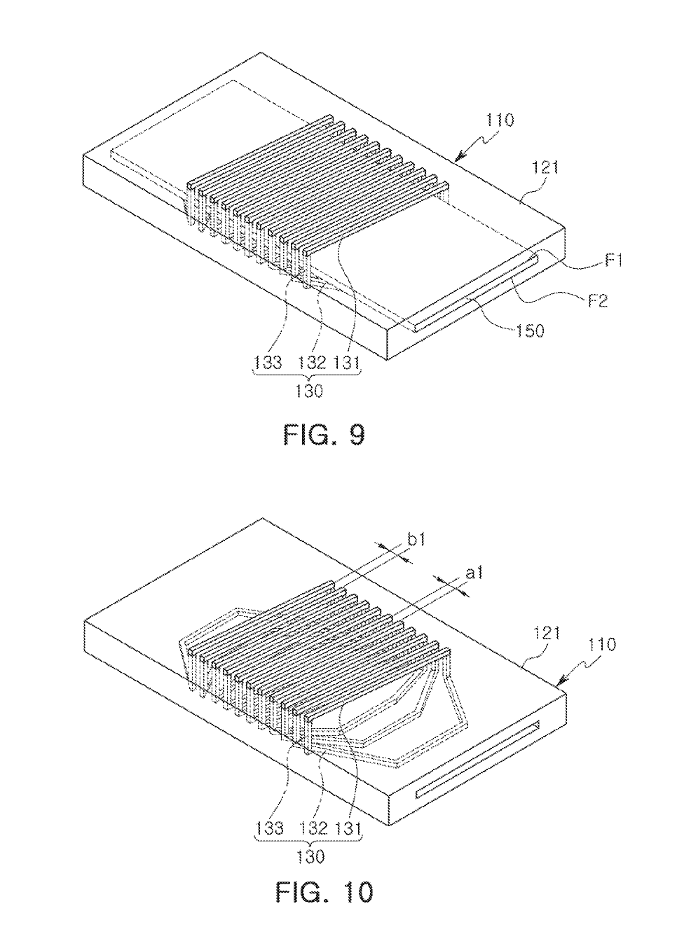

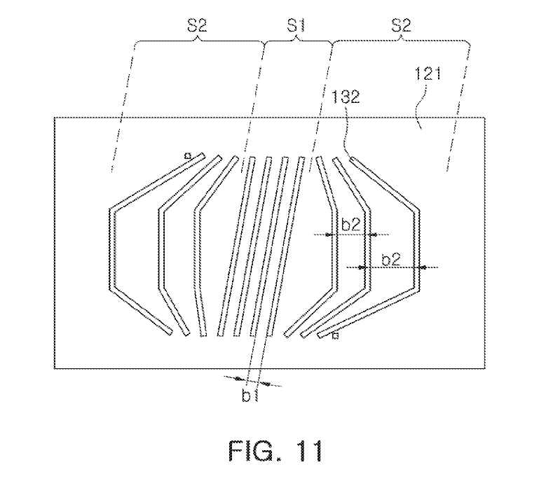

FIG. 9 is a schematic perspective view illustrating an antenna device according to an embodiment, FIG. 10 is a perspective view illustrating the antenna device illustrated in FIG. 9 without a magnetic portion, and FIG. 11 is a bottom view of the antenna device illustrated in FIG. 9.

Referring to FIGS. 9 through 11, in the antenna device according to an embodiment, a coil portion 110 may include an insulating substrate 121 and an antenna wiring 130 formed of a thin film metal wiring on the insulating substrate 121. In addition, a magnetic portion 150 may be inserted into the insulating substrate 121.

The magnetic portion 150 may be configured to be similar to that in the abovementioned embodiments. In addition, in an embodiment, the magnetic portion 150 is inserted into the insulating substrate 121, and may thus be formed in a sheet shape in order to significantly decrease a thickness of an antenna device.

The insulating substrate 121, which is an insulating plate having the antenna wiring 130 formed on one surface or opposite surfaces thereof, may be an insulating film (for example, a polyimide film). However, the insulating substrate 121 is not limited thereto, and various materials may be used as the insulating substrate 121 as long as they have a small thickness and the antenna wiring 130 may be formed on opposite surfaces of them in a printing manner, a photolithography manner, or the like.

In an embodiment, the magnetic portion 150 may be disposed in the insulating substrate 121. Therefore, in an embodiment, the insulating substrate 121 may be formed by stacking and disposing two insulating films on upper and lower surfaces of the magnetic portion 150 and then pressing the two insulating substrates to bond the two insulating substrates to each other. However, a method of disposing the magnetic portion 150 in the insulating substrate 121 is not limited thereto, and various methods such as a method of forming a hole in the insulating substrate 121 and then inserting the magnetic portion 150 into the hole may be used as long as the magnetic portion 150 may be disposed in the insulating substrate 121.

The antenna wiring 130 may be disposed on opposite surfaces of the insulating substrate 121, and may be formed of the thin film metal wiring such as a copper foil.

The antenna wiring 130 may include first wirings 131 formed on a first surface F1 of the magnetic portion 150, second wirings 132 formed on a second surface F2 of the magnetic portion 150, and a plurality of connection conductors 133 disposed to penetrate through the insulating substrate 121 in order to electrically connect the first wirings 131 and the second wirings 132 to each other.

Similar to the abovementioned embodiment, all of the first wirings 131 may be disposed to be spaced apart from each other by the same intervals (a1 and b1). However, the antenna wiring is not limited thereto, but may be variously modified. For example, as in a case of FIG. 6, intervals b1 between turns in the second section S2 may be formed to be small or great.

The second wirings 132 may be disposed to be spaced apart from each other by approximately the same interval b1 in the first section S1. In addition, in the second section S2, the intervals b2 between the turns may be increased toward end portions. In an embodiment, a case in which the second wirings 132 disposed in the second sections S2 have a shape similar to a trapezoidal shape and have two bending points is described by way of example, but a shape of the second wirings 132 is not limited thereto, but may be variously modified, as necessary. For example, the second wirings 132 may have a parabolic shape or a sharp triangular shape.

The connection conductors 133 may electrically connect the first wirings 131 and the second wirings 132 to each other. Therefore, in the antenna wiring 130, the first wirings 132, the connection conductors 133, and the second wirings 132 may be sequentially connected repeatedly to each other to form a solenoid structure.

The coil portion 110 according to an embodiment configured as described above may be manufactured by patterning an insulating film having a copper foil stacked on one surface thereof, and may be manufactured in a form of, for example, a flexible printed circuit board (FPCB). In this case, the antenna device according to an embodiment may be formed at a very small thickness. However, the coil portion 110 may also be manufactured in a form of a multilayer substrate or be manufactured in a form of a PCB having rigidity, as necessary.

As set forth above, an antenna device according to one general aspect may have a high recognition rate of the antenna device may be maintained in a wireless communications process between the portable terminal and the wireless signal receiving device.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An antenna device comprising:
a magnetic portion comprising a first surface and a second surface opposing the first surface; and
a coil portion including conductive wiring comprising a plurality of turns wound around the magnetic portion in a solenoid form,
wherein in the coil portion, intervals between turns of the conductive wiring disposed on the first surface and intervals between turns of the conductive wiring disposed on the second surface are different from each other.

2. The antenna device of claim 1, wherein the conductive wiring included in the coil portion is differentially disposed in a first section, in a central portion of the magnetic portion, and second sections at respective end portions of the magnetic portion, and
intervals between turns of the conductive wiring in the first section and intervals between turns of the conductive wiring in the second sections are different from each other.

3. The antenna device of claim 2, wherein, in the conductive wiring included in the coil portion, the intervals between turns of the conductive wiring disposed on the second surface, in the second sections, are greater than the intervals between turns of the conductive wiring disposed on the first surface in the second sections.

4. The antenna device of claim 3, wherein, in the conductive wiring included in the coil portion, the intervals between the turns of the conductive wiring disposed on the second surface are increased respectively toward the end portions of the magnetic portion.

5. The antenna device of claim 3, wherein all of the intervals between the turns of the conductive wiring disposed on the first surface are substantially the same.

6. The antenna device of claim 3, wherein the intervals between turns of the conductive wiring disposed on the first surface, in the second sections, are smaller than the intervals of between turns of the conductive wiring disposed on the first surface in the first section.

7. The antenna device of claim 1, wherein the first surface of the magnetic portion has an area smaller than that of the second surface of the magnetic portion, and both end portions of the magnetic portion comprise inclined surfaces.

8. The antenna device of claim 1, wherein the magnetic portion comprises protruding portions on both ends of the first surface, and the conductive wiring disposed on the first surface is disposed between the protruding portions.

9. The antenna device of claim 1, wherein insertion grooves into which the conductive wiring is inserted are disposed in a surface of the magnetic portion.

10. The antenna device of claim 1, wherein the coil portion comprises an insulating substrate into which the magnetic portion is inserted, and
the conductive wiring comprises thin film metal wirings on opposite surfaces of the insulating substrate.

11. The antenna device of claim 10, wherein the coil portion comprises a plurality of connection conductors penetrating through the insulating substrate and electrically connecting the conductive wiring respectively disposed on the opposite surfaces of the insulating substrate to each other.

12. A portable terminal comprising:
a terminal body; and
an antenna device comprising a magnetic portion comprising a second surface facing the terminal body and a first surface opposing the second surface, and a coil portion including conductive wiring wound around the magnetic portion in a solenoid form, an entire length of the coil portion disposed on the second surface being greater than that of the coil portion disposed on the first surface.

13. The portable terminal of claim 12, wherein the antenna device is a magnetic secure transmission (MST) antenna device.

14. The portable terminal of claim 12, wherein the coil portion includes an insulating substrate comprising the conductive wiring disposed on a surface thereof, and the magnetic portion is disposed in a flat sheet shape and is inserted into the insulating substrate.

15. The portable terminal of claim 12, wherein, in the conductive wiring included in the coil portion, intervals between turns of the conductive wiring disposed on the first surface and intervals between turns of the conductive wiring disposed on the second surface are different from each other.

16. The portable terminal of claim 15, wherein, in the conductive wiring included in the coil portion, the intervals between the turns of the conductive wiring disposed on the second surface are increased respectively toward end portions of the magnetic portion.

17. The antenna device of claim 1, wherein the antenna device is magnetically coupled to a wireless signal receiving device to wirelessly transmit information.

18. The antenna device of claim 1, wherein the antenna device is a near field communications (NFC) antenna device or radio frequency identification (RFID) antenna device.
